(19) United States
(12) Patent Application Publication
(10) Pub. No.: US 2026/0154573 A1
(43) Pub. Date: Jun. 4, 2026

(54) DATA PROCESSING METHOD AND ELECTRONIC DEVICE

(71) Applicant: Lenovo (Beijing) Limited, Beijing (CN)

(72) Inventor: Gang HE, Beijing (CN)

(21) Appl. No.: 19/394,205

(22) Filed: Nov. 19, 2025

(30) Foreign Application Priority Data
Nov. 29, 2024 (CN) 202411750356.7

(51) Int. Cl. G06N 5/022; G06F 11/34

(52) U.S. Cl. CPC G06N 5/022; G06F 11/3409

(57) ABSTRACT

A method of data processing includes obtaining a target input, obtaining, in response to the target input meeting a condition, first information, and outputting second information based on the first information. The second information prompts a time for obtaining a target output generated by a target model based on the target input, and the time is related to the first information.

### CROSS-REFERENCE TO RELATED APPLICATION

This application claims priority to Chinese Patent Application No. 202411750356.7, filed on Nov. 29, 2024, the entire content of which is incorporated herein by reference.

### TECHNICAL FIELD

The present disclosure generally relates to the artificial intelligence field and, more particularly, to a data processing method and an electronic device.

### BACKGROUND

With the development of artificial intelligence technology, model-based data processing systems are becoming increasingly popular. The current data processing system has a single mode of outputting reply information after receiving the input information of the user, which is less intelligent.

### SUMMARY

In accordance with the disclosure, there is provided a method of data processing including obtaining a target input, obtaining, in response to the target input meeting a condition, first information, and outputting second information based on the first information. The second information prompts a time for obtaining a target output generated by a target model based on the target input, and the time is related to the first information.

Also in accordance with the disclosure, there is provided a method of data processing including obtaining a target input, obtaining first information related to an input object in response to the target input meeting a condition, and outputting second information based on the first information. The second information includes a first output or a second output generated by a target model based on the target input, and the first output is different from the second output.

Also in accordance with the disclosure, there is provided a method of data processing including obtaining a target input, obtaining information in response to the target input meeting a condition, and determining, based on the information, a target policy for generating a target output. The target policy includes at least one of: selecting a target model matching the information from a plurality of models, and generating a target output based on the target model; determining a number of times of calling the target model according to the information; determining, according to the information, one or more steps by which the target model generates the target output based on the target input and target information; determining, according to the information, a depth of searching information in a preset information source or a selected knowledge base based on the target input; or determining, according to the information, a breadth of searching information in the preset information source or the selected knowledge base based on the target input.

### BRIEF DESCRIPTION OF THE DRAWINGS

The above and other features, advantages, and aspects of embodiments of the present disclosure will become more apparent by reference to the following detailed description when taken in conjunction with the accompanying drawings. The same or similar reference numbers will be used throughout the drawings to refer to the same or like elements. The figures are schematic, and elements and components are not necessarily drawn to scale.

FIG. 1 is a schematic flowchart of a data processing method provided by the present disclosure.

FIG. 2A is a schematic flowchart of obtaining first information and outputting second information based on the first information consistent with the present disclosure.

FIG. 2B is a schematic diagram showing an interaction example of obtaining first information after obtaining a target input and outputting second information based on the first information consistent with the present disclosure.

FIG. 3A is another schematic flowchart of obtaining first information and outputting second information based on the first information consistent with the present disclosure.

FIG. 3B is a schematic diagram showing another interaction example of obtaining first information after obtaining a target input and outputting second information based on the first information consistent with the present disclosure.

FIG. 4A is another schematic flowchart of obtaining first information and outputting second information based on the first information consistent with the present disclosure.

FIG. 4B is a schematic diagram showing another interaction example of obtaining first information after obtaining a target input and outputting second information based on the first information consistent with the present disclosure.

FIG. 5A is another schematic flowchart of another implementation of obtaining first information and outputting second information based on the first information consistent with the present disclosure.

FIG. 5B is a schematic diagram showing another interaction example of obtaining the first information after obtaining the target input and outputting the second information based on the first information consistent with the present disclosure.

FIG. 6 is a diagram showing an interaction example of obtaining first information after obtaining a target input and outputting third information based on the first information consistent with the present disclosure.

FIG. 7A is another schematic flowchart of the data processing method consistent with the present disclosure.

FIG. 7B is a schematic diagram showing an interaction example of obtaining first information after obtaining the target input by the first input object A and outputting fourth information based on the first information consistent with the present disclosure.

FIG. 7C is a schematic diagram showing another interaction example of obtaining first information after obtaining the target input by the second input object B and outputting fourth information based on the first information consistent with the present disclosure.

FIG. 7D is a schematic diagram of another interaction example of obtaining the first information after obtaining the target input by the first input object A and outputting the fourth information based on the first information consistent with the present disclosure.

FIG. 7E is a schematic diagram showing another interaction example of obtaining first information after obtaining the target input by the first input object A and outputting fourth information based on the first information consistent with the present disclosure.

FIG. 7F is a schematic diagram of another interaction example of obtaining first information and outputting fourth information based on the first information after obtaining a target input of an input object input consistent with the present disclosure.

FIG. 7G is a schematic diagram of another interaction example of obtaining first information after obtaining a target input of an input object input and outputting fourth information based on the first information consistent with the present disclosure.

FIG. 7H is a schematic diagram showing outputting sixth information consistent with the present disclosure.

FIG. 8 is another schematic flowchart of a data processing method consistent with the present disclosure.

FIG. 9 is a schematic structural diagram of an electronic device consistent with the present disclosure.

### DETAILED DESCRIPTION OF THE EMBODIMENTS

Embodiments of the present disclosure are described below with reference to the drawings. The terms used in the embodiments of the present disclosure are only for explaining the specific embodiments of the present disclosure and are not intended to limit the present disclosure. It is known to those skilled in the art that, with the development of technology and the emergence of new scenarios, the technical solutions provided in the embodiments of the present disclosure are also applicable to similar technical problems.

The terms “first,” “second” etc. in the specification and claims of this application and the above-mentioned drawings are used to distinguish similar elements and are not necessarily used to describe a specific order or sequence. The terms used in this manner are interchangeable under appropriate circumstances, and this is merely a way of distinguishing objects with the same attributes in the embodiments of the present disclosure. Furthermore, the terms “including,” “comprising,” and “having,” and any variations thereof, are intended to cover a non-exclusive inclusion, so that a process, method, system, product, or device that includes a list of elements is not necessarily limited to those elements but may include other elements not expressly listed or inherent to such process, method, product, or device.

The data processing method provided by the embodiments of the present disclosure can be used for electronic device, wherein the electronic device is deployed with a machine learning Model, such as a neural network Model, and the neural network Model can include, but is not limited to any one of convolutional neural network (CNN), deep convolutional network (DCN), cyclic neural network (RNN), large model etc. The large model may include, but is not limited to, any of a large language model (LLMs), a multi modal large model (MLLMs), etc.

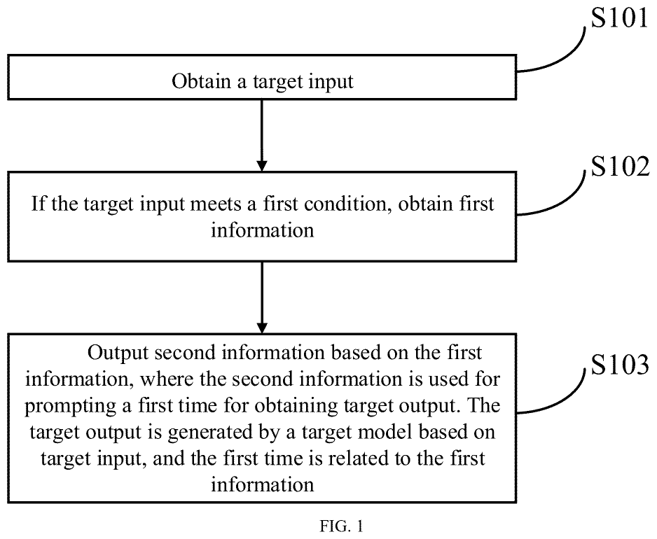

A flowchart of a data processing method provided by the present disclosure is shown in FIG. 1, which is described below.

At S101, a target input is obtained.

The target input is interactive content entered by an input object (e.g., a user) and may include, but is not limited to, content in at least one of text, files, pictures, etc.

At S102, if the target input meets a first condition, first information is obtained.

The first condition is used for judging whether second information needs to be output or not to prompt the time when the input object obtains the target output based on the target input.

The target input meeting a first condition may include that the target input is a complex problem.

For example, the complexity of the target input may be determined. If the complexity is greater than the target complexity, the target input is determined to be a complexity problem. Otherwise, the target input is determined not to be a complexity problem. Determining the complexity of the target input may include any of the following.

Semantic analysis is executed on the target input to determine the amount of semantics contained in the target input (i.e., the amount of different semantic information contained in the target input). The complexity of the target input is positively correlated with the amount of semantics contained in the target input, i.e., the greater the amount of semantics contained in the target input, the greater the complexity of the target input.

Semantic analysis is executed on the target input to determine the correlation between each semantic information contained in the target input. The complexity of the target input is positively correlated with the correlation between each semantic information contained in the target input, i.e., the greater the correlation between each semantic information contained in the target input, the greater the complexity of the target input.

For example, the target input may be processed by a pre-trained classification model, to obtain a classification result corresponding to the target input, the classification result characterizes whether the target input is a complicated problem.

The first information may include information related to at least one of an input object, an input environment, or an electronic device.

At S103, second information is output based on the first information, where the second information is used for prompting a first time for obtaining target output. The target output is generated by a target model based on target input, and the first time is related to the first information.

Consistent with the present disclosure, before the target model generates the target output based on the target input, the time of obtaining the target output is estimated based on the first information, and then the second information is output, so that the input object can get the feedback time (i.e., the first time) of the target output.

According to the data processing method provided by the embodiments of the present disclosure, after the target input is obtained, if the target input meets the first condition, the second information is output based on the first information so as to inform the input object of how long the target output can be obtained, and then the target model is used for generating and outputting the target output based on the target input. As such, the output mode is modified to provide input object a clear understanding of the specific situation of the interactive system obtaining the target output based on the target input. This increases the variety of interaction modes with the input object, thereby improving the intelligence of the data processing system based on the large model and meeting the needs of the input object for intelligent interaction.

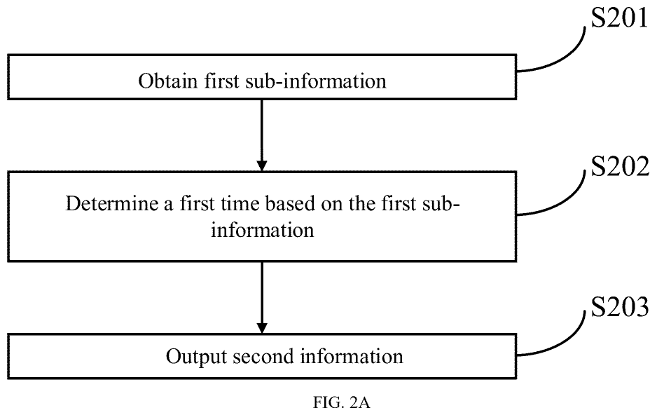

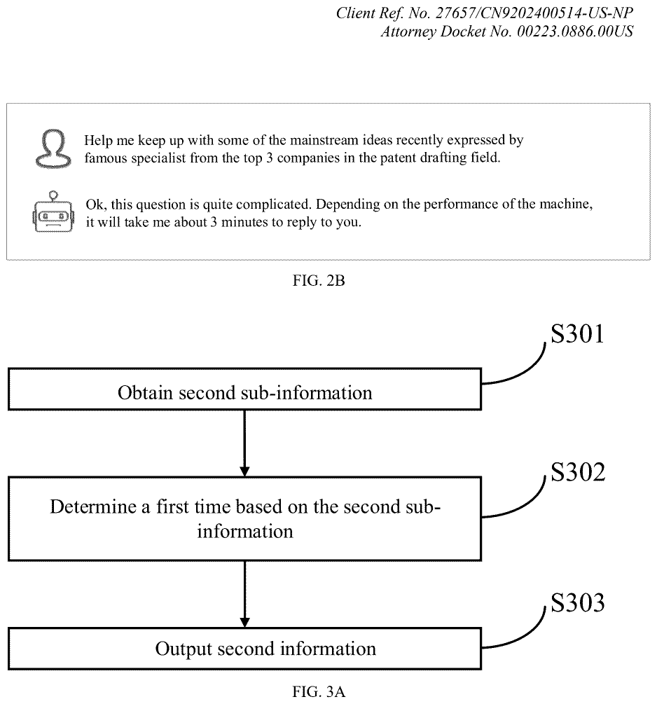

In some embodiments, as shown in FIG. 2A, the above-mentioned obtaining the first information and outputting the second information based on the first information may include the following.

At S201, first sub-information is obtained.

The first sub-information is included in the first information, i.e., the first information includes the first sub-information. The first sub-information characterizes the processing performance of an electronic device running the target model. The first sub-information may include, but is not limited to, at least part of the information of the number of cores, main frequency and cache size of the processor, memory capacity and frequency, hard disk type and storage capacity, video memory size, number of stream processors, bus width, performance of the installed software, etc.

The processing performance of the electronic device is positively correlated with the core number of the processor, i.e., the more core number of the processor has, the higher the processing performance of the electronic device.

The processing performance of the electronic device is positively correlated with the main frequency of the processor, i.e., the higher the main frequency of the processor, the faster the operation speed and the higher the processing performance of the electronic device.

The processing performance of the electronic device is positively correlated with the cache size of the processor, i.e., the larger the cache size of the processor, the faster the data processing speed of the processor, and the higher the processing performance of the electronic device.

The processing performance of the electronic device is positively correlated with the memory capacity of the electronic device, i.e., the larger the memory capacity of the electronic device, the higher the processing performance.

The processing performance of the electronic device is positively correlated with the memory frequency of the electronic device, i.e., the higher the memory frequency of the electronic device, the faster the data transmission of the memory, and the higher the processing performance of the electronic device.

Different types of hard drives have different read and write speeds, and electronic devices have different processing performance. The processing performance of the electronic device is positively correlated with the read-write speed of the hard disk, i.e., the higher the read-write speed of the hard disk, the higher the processing performance of the electronic device.

The processing performance of the electronic device is positively correlated with the storage capacity of the hard disk, i.e., the larger the storage capacity of the hard disk, the higher the processing performance of the electronic device.

The processing performance of the electronic device is positively correlated with the size of the video memory, i.e., the larger the video memory, the stronger the capability of the video card for processing images and videos, and the higher the processing performance of the electronic device.

The stream processor is a core processing unit in the graphics card, and the processing performance of the electronic device is positively correlated with the number of the stream processors in the graphics card, i.e., the higher the number of the stream processors, the better the processing performance of the graphics card, and the higher the processing performance of the electronic device.

The wider the bus width, the faster the data transfer and the higher the processing performance of the electronic device.

The higher the performance of the software invoked by the electronic device, the higher the processing performance of the electronic device.

At S202, a first time (i.e., the time it takes for the target model to generate the target output based on the target input) is determined based on the first sub-information.

In some embodiments, the higher the processing performance of the electronic device is represented by the first sub-information, the shorter the first time it takes for the target model to generate the target output based on the target input; otherwise, the lower the processing performance of the electronic device is represented by the first sub-information, the longer the first time it takes for the target model to generate the target output based on the target input.

At S203, second information is output. The second information carries a first time determined based on the first sub-information.

FIG. 2B shows an interaction example of obtaining first information after obtaining a target input and outputting second information based on the first information according to the present disclosure. In this example, the target input is “Help me keep up with some of the mainstream ideas recently expressed by famous experts from the top 3 companies in the patent drafting field.” the second information is “Ok, this question is quite complicated. Depending on the performance of the machine, it will take me about 3 minutes to reply to you.”.

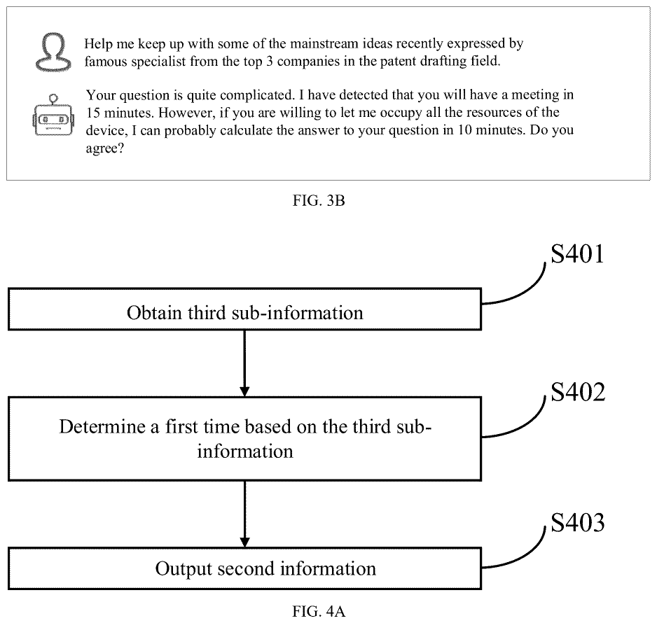

In some embodiments, another flowchart for obtaining the first information and outputting the second information based on the first information is shown in FIG. 3A, which includes the following.

At S301, second sub-information is obtained.

The second sub-information is included in the first information, i.e., the first information includes the second sub-information. The second sub-information characterizes occupancy of available processing resources of the electronic device by the non-target model.

The processing resources of the electronic device may include, but are not limited to, processors, memory, etc.

The available processing resources of the electronic device are the available processing resources of the electronic device when the electronic device obtains the target input.

The non-target model may include other applications that will be run in the electronic device besides the target model. The non-target model may be determined according to schedule information of the input object. For example, the user calendar information shows that the user has a meeting at 15:00-16:00, then the non-target model may include meeting software.

The occupancy of available processing resources by non-target models may include but is not limited to, the start time when the available processing resources are occupied by the non-target model, the duration of time the available processing resources are occupied by the non-target model, the proportion of available processing resources occupied by the non-target model, the priority of the non-target model, etc.

At S302, a first time (i.e., the time it takes for the target model to generate the target output based on the target input) is determined based on the second sub-information.

In some embodiments, before the non-target model starts occupying the available processing resources, if the target model cannot generate the target output based on the target input, the target model and the non-target model will occupy the available processing resources simultaneously. The second sub-information characterizes occupancy of available processing resources by the non-target model. The longer the duration of time characterized by the second sub-information, the longer the first time. The larger the proportion characterized by the second sub-information, the smaller the proportion of the available processing resources occupied by the target model, and the longer the first time. The higher the priority of the non-target model characterized by the second sub-information, the larger the proportion of the available processing resources occupied by the non-target model, the smaller the proportion of the available processing resources occupied by the target model, and the longer the first time.

In some embodiments, before the non-target model begins to occupy the available processing resources, if the target model is able to generate a target output based on the target input, a first time at which the target model generates the target output based on the target input is determined based on the currently available processing resources (i.e., when there are applications that are occupying the processing resources, without suspending the applications currently occupying the processing resources, the target model occupies only a portion of the processing resources of an electronic device).

In some embodiments, before the non-target model begins to occupy the available processing resources, if the target model occupies all the processing resources of the electronic device(i.e., when there are applications that are currently occupying processing resources, suspend the applications that are currently occupying processing resources) and is able to generate a target output based on the target input, then the first time at which the target model generates the target output based on the target input is determined based on all processing resources of the electronic device. This results in a shorter time to obtain the target output. In this case, interaction information may also be output to query whether the input object agrees to occupy all the processing resources of the electronic device to generate the target output before the non-target model begins to occupy the processing resources. If the input object chooses to agree, suspend the applications currently occupying the processing resources, and occupy all the processing resources of the electronic device to run the target model, so the target model can generate target output quickly based on the target input. If the input object chooses to disagree, the application program currently occupying the processing resources continues to run, and the first time is determined based on the above two embodiments.

At S303, second information is output. The second information carries the first time determined based on the second sub-information.

Another interaction example diagram of obtaining first information and outputting second information based on the first information after obtaining the target input is shown in FIG. 3B. In this example, the target input is “Help me keep up with some of the mainstream ideas recently expressed by famous experts from the top 3 companies in the patent drafting field.” the second information is “Your question is quite complicated. I have detected that you will have a meeting in 15 minutes. However, if you are willing to let me occupy all the resources of the device, I can probably calculate the answer to your question in 10 minutes. Do you agree?”.

In some embodiments, another flowchart for obtaining the first information and outputting the second information based on the first information is shown in FIG. 4A, which includes the following.

At S401, third sub-information is obtained. The third sub-information characterizes the understanding of the domain to which the target input belongs by the input object.

The third sub-information is included in the first information, i.e., the first information includes the third sub-information. The third sub-information may include, but is not limited to, the browsing history of the input object, the job title of the input object, the years of working experience of the input object, etc. The more the information of the domain to which the target input belongs browsed by the input object characterized by the browsing history, the better the understanding of domain to which the target input belongs by the input object. The higher the job title of the input object, the better the understanding of domain to which the target input belongs. The longer the years of working experience of the input object, the better the understanding of domain to which the target input belongs by the input object.

At S402, a first time (i.e., the time it takes for the target model to generate the target output based on the target input) is determined based on the third sub-information.

The better the understanding of domain to which the target input belongs by the input object, the more in-depth response needs to be given, i.e., the higher quality responses require more time, so the first time is longer. Otherwise, the first time is shorter.

At S403, second information is output. The second information carries the first time determined based on the third sub-information.

In some embodiments, the first information includes at least one of the first sub-information, the second sub-information, or the third sub-information.

When the first information includes at least two of the three pieces of sub-information described above, the first time (i.e., the time it takes for the target model to generate the target output based on the target input) can be determined by considering the at least two pieces of sub-information in the first information. Reference can be made to above disclosure for the association relationship between the first time and various sub-information.

Another interaction example diagram of obtaining the first information after obtaining the target input, the second information is output based on the first information is shown in FIG. 4B. In this example, the target input is “Help me keep up with some of the mainstream ideas recently expressed by famous experts from the top 3 companies in the patent drafting field,” and the second information is “Your question is quite complicated. Considering that you are a practitioner in the patent field, I need to search and organize the relevant materials in depth and reply to you in about 12 minutes.”

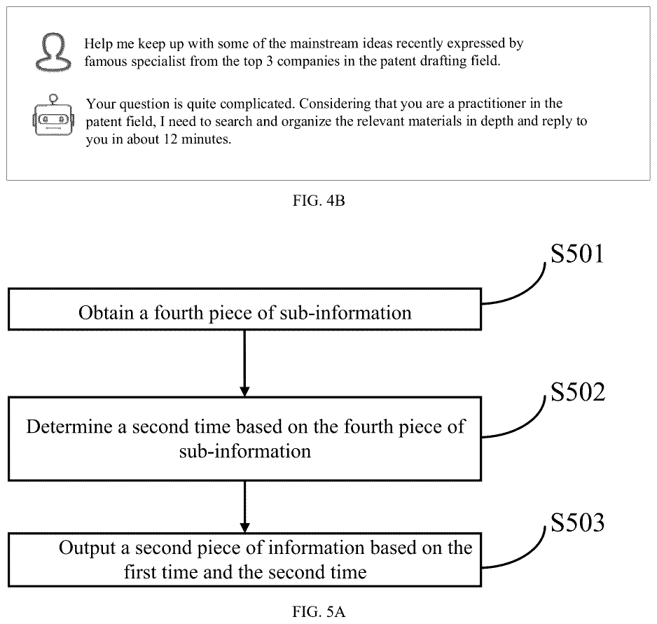

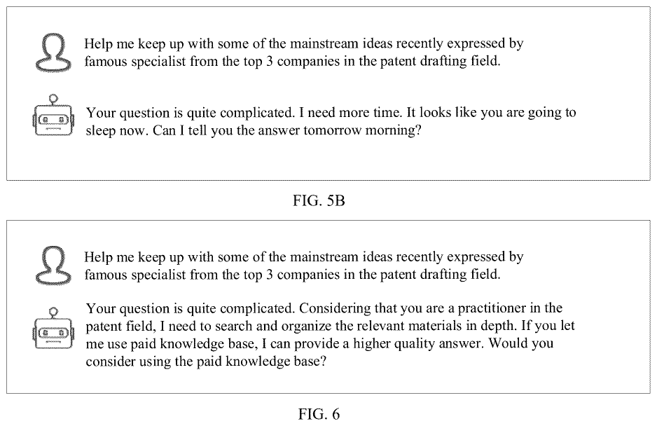

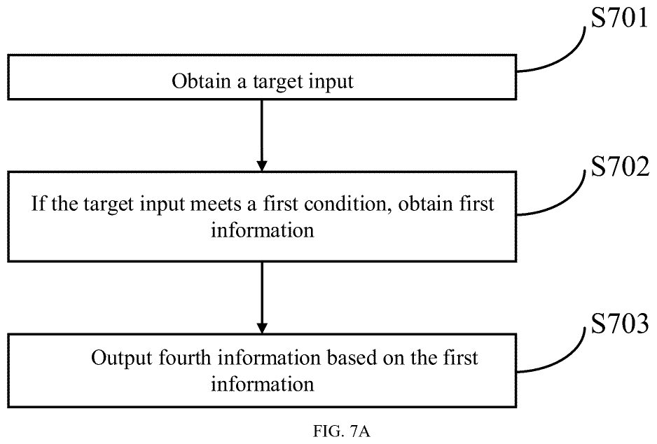

In some embodiments, another flowchart of obtaining the first information and outputting the second information based on the first information is shown in FIG. 5A, which includes the following.

At S501, fourth sub-information is obtained.

The fourth sub-information is included in the first information, i.e., the first information includes the fourth sub-information. The fourth sub-information is related to the input object and/or the input environment.

In some embodiments, the fourth sub-information related to the input object may characterize the personality of the input object. In this disclosure, the fourth sub-information may include a user persona determined based on the daily behavior of the input object, where the user persona characterizes whether the input object has patience. For example, after inputting information, the input object often executes other operations before the target output is fully displayed; or, while waiting for the target output, the input object often shakes the mouse aimlessly, or clicks the mouse, etc. All these behaviors indicate that the input object has an impatient personality. In this case, you can add an impatient label to the user persona to indicate that the user has an impatient personality.

In some embodiments, the fourth sub-information related to the input environment may include the time and place where the input object is currently at.

At S502, a second time is determined based on the fourth sub-information. The second time characterizes the time that the input object can wait.

In some embodiments, if the input object has a more impatient personality, the input object can wait for a shorter time, and if the input object has a more patient personality, the input object can wait for a longer time.

If the input object is currently in the first target time period (e.g., 9:00-22:00) and is at the first target location (e.g., company), then the input object is considered to be still working and the input object hopes to obtain the target output quickly, that is, the input object can wait for a quite short time.

For example, if the input object is not currently in the first target time period and the is at a second target location (e.g., home), then it is considered that the input object may need to sleep and can wait for a quite long time.

At S503, second information is output based on the first time and the second time. The second information is also used to prompt the input object to trigger the target model to run or execute other tasks.

That is, consistent with the present disclosure, before the target output is generated by the target model based on the target input, in addition to obtaining the first time of the target model generates the target output based on the target input, the second time of the input object can wait is also obtained.

The output second information not only prompts the first time of obtaining the target output, but also prompts the input object to trigger the target model to run to output the target output within the second time or the third time, or prompts the input object to execute other tasks.

The input object may execute other tasks through the electronic device (e.g., continue to use the electronic device, at which time the target model may simultaneously generate target output based on the target input in the background), or may not execute other tasks through the electronic device (e.g., sleep, read books, exercise, etc.).

Another interaction example of obtaining the first information after obtaining the target input, and the second information is output based on the first information is shown in FIG. 5B. In this example, the target input is “Help me keep up with some of the mainstream ideas recently expressed by famous experts from the top 3 companies in the patent drafting field.” The second information is “Your question is quite complicated. I need more time. It looks like you are going to sleep now. Can I tell you the answer tomorrow morning?”.

If the fourth sub-information characterizes that the input object has more patient personality, the second information prompts the input object to trigger the target model to run so as to output target output in a second time.

If the fourth sub-information characterizes that the input object has more patient personality and the waiting time of the input object is less than a time threshold, the second information prompts the input object to trigger the target model to run so as to output the target output in a third time. The third time is determined based on the second time and is greater than the second time, and the difference between the third time and the second time is less than the preset difference. The input object is quite impatient, if the second information prompts the input object to trigger the target model to run to output the target output within the second time, when the input object's waiting time is about to reach the second time, the input object may not be able to wait to see the output result, but at this time the complete result has not been output yet. If the second information prompts the input object to trigger the target model to run to output the target output within the third time, the target output may be obtained before the input object's waiting time reaches the third time, thereby improving the user experience.

In some embodiments, if the first information includes third sub-information, the third sub-information characterizes the understanding of a domain to which the target input belongs by the input object, and if the understanding of the domain to which the target input belongs by the input object meets a second condition, the third information may be output based on the first time, where the third information is used to prompt the input object to select the knowledge base.

For example, the understanding of a domain to which the target input belongs by the input object meeting the second condition includes the degree of understanding of the domain to which the target input belongs by the input object being greater than a degree threshold.

If the input object's understanding of the domain to which the target input belongs meets the second condition, it devices that the input object has a relatively better understanding of the domain to which the target input belongs and is a professional in the domain to which the target input belongs, providing a more in-depth target output is needed. To provide a more in-depth target output, reference can be made to more professional knowledge bases. More professional knowledge bases may require payment. At this time, the third information can be output to ask the input object whether to pay to select a more professional knowledge base.

FIG. 6 is a schematic diagram of an interaction example of obtaining first information and outputting third information based on the first information after obtaining a target input according to an embodiment of the present disclosure. In this example, the target input is “Help me keep up with some of the mainstream ideas recently expressed by famous experts from the top 3 companies in the patent drafting field.” The third information is “Your question is quite complicated. Considering that you are a practitioner in the patent field, I need to search and organize the relevant materials in depth. If you let me use paid knowledge base, I can provide a higher quality answer. Would you consider using the paid knowledge base?”.

Further, if the user selects to pay to select a more professional knowledge base, the target model will refer to the more professional knowledge base to generate target output based on the target input, otherwise, will not refer to the more professional knowledge base.

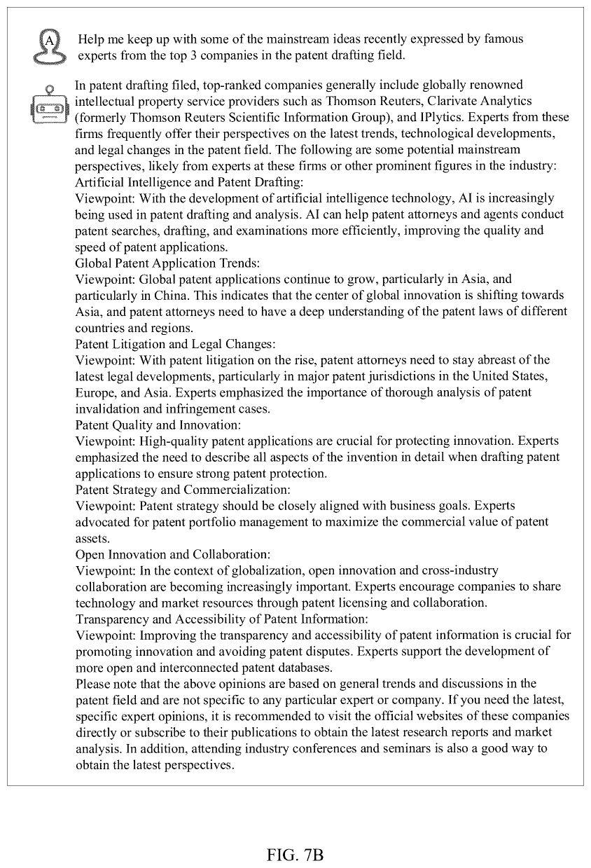

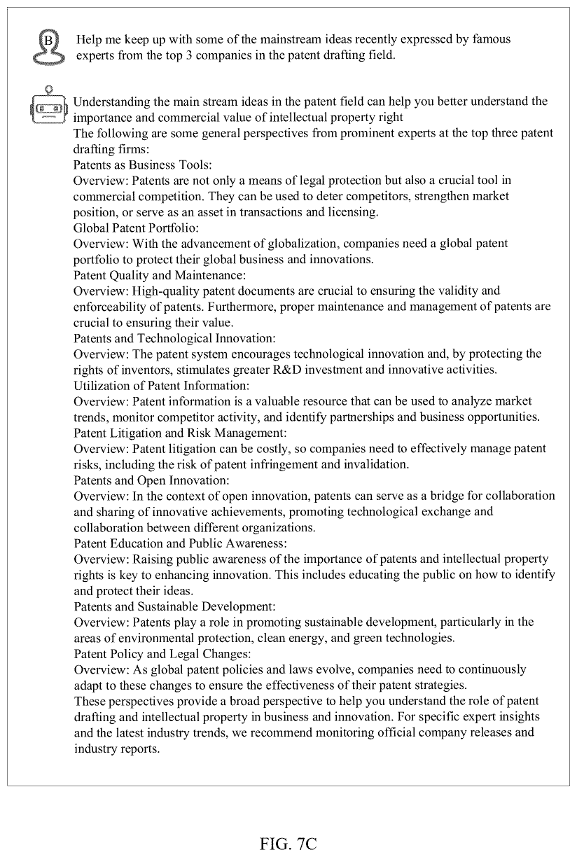

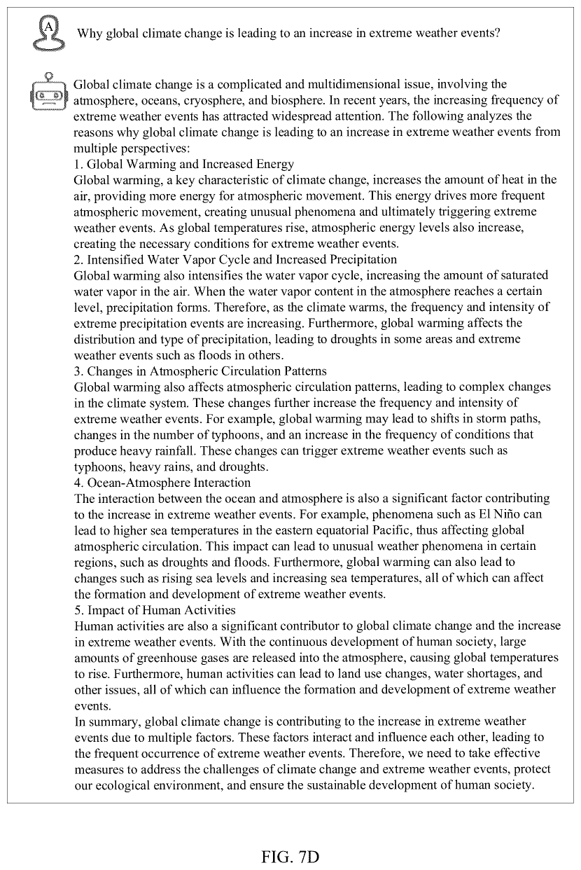

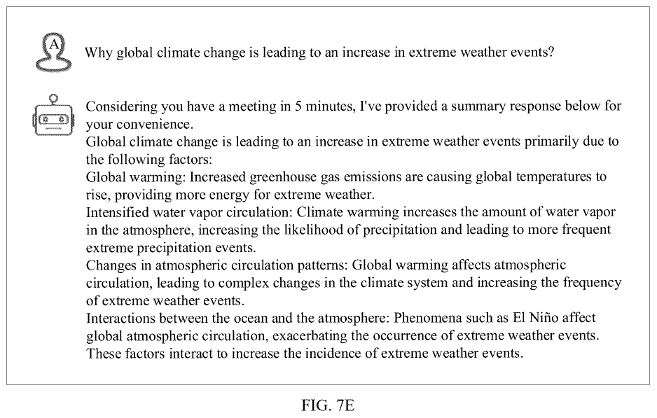

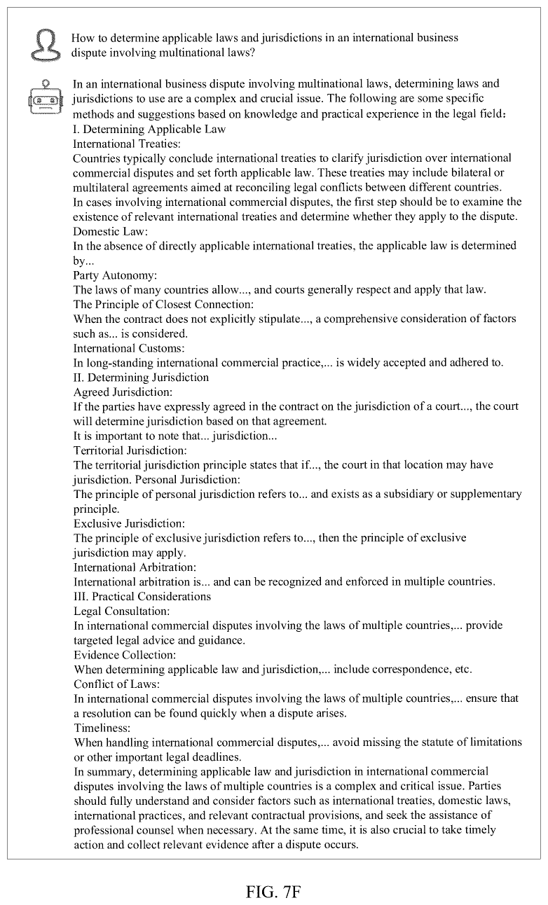

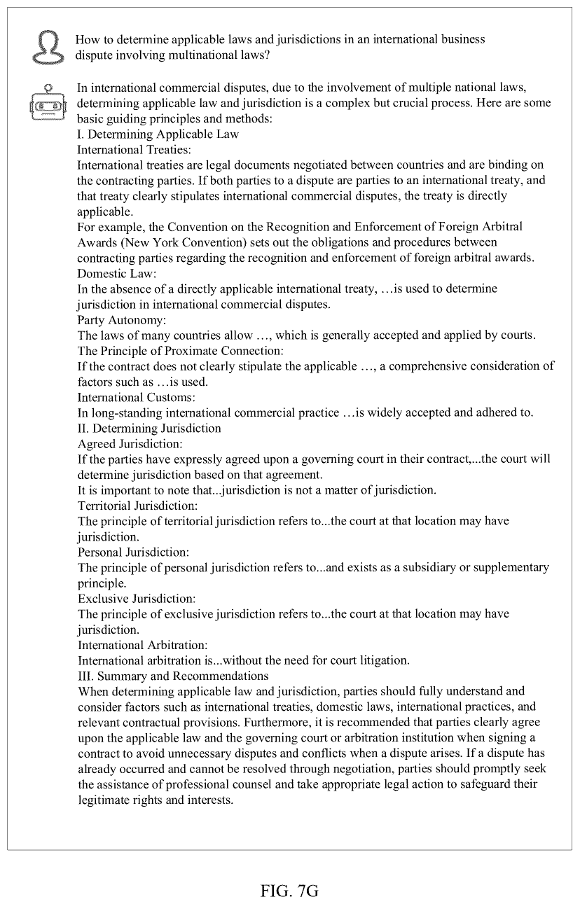

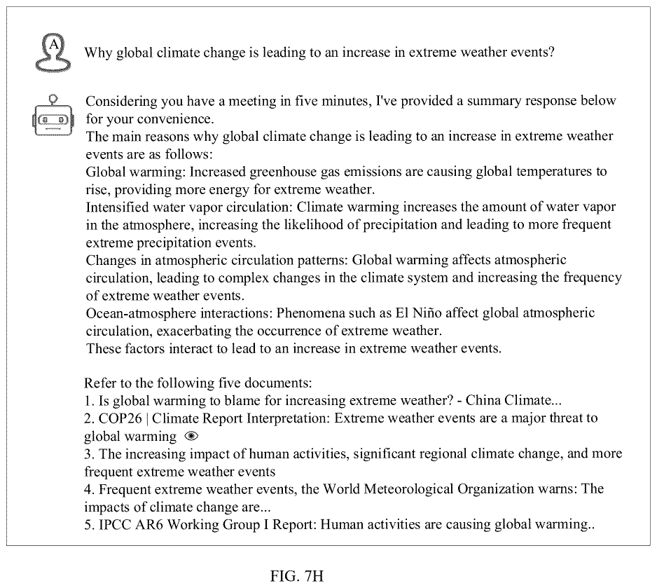

Another implementation flowchart of the data processing method provided by the embodiments of the present disclosure is shown in FIG. 7A, which includes the following.

At S701, a target input is obtained.

The target input is interactive content input by an input object (e.g., a user) and may include, but is not limited to, content in at least one of the following formats: text, file, image, etc.

At S702, if the target input meets the first condition, first information is obtained. The first information is related to the input object.

The first condition is used to determine whether personalized output is needed for the input object.

In some embodiments, the target input meeting the first condition may include the target input is a complicate question. Reference can be made to above embodiments for determining whether the target input is a complex question.

In some embodiments, the first information may include characteristic information of the input object and/or the environment in which the input object is located. The characteristic information of the input object may include, but is not limited to, at least one of the following: identity information, personality, browsing history, job title, years of work experience, or other characteristics of the input object. The environment in which the input object is located may include, but is not limited to, at least one of the following: the time of day, the location of the input object, etc.

At S703, fourth information is output based on the first information. The fourth information includes a first output or a second output. The first output or the second output generated by the object model based on the object input, and the first output is different from the second output.

That is, for different first information obtained, the fourth information generated by the object model based on the object input is different.

In some embodiments, a knowledge base can be determined based on the first information, relevant knowledge is searched in the determined knowledge base according to the target input, and fourth information is generated by the target model based on the target input according to the searched relevant knowledge.

Depending on the first information, the determined knowledge base may be different. When the determined knowledge base is different, the searched related knowledge is different. Therefore, the fourth information generated by the target model based on the target input according to the searched related knowledge is also different.

In some embodiments, the related knowledge may be searched in a preset knowledge base according to the target input (i.e., the related knowledge is searched in the same knowledge base regardless of the first information), and the fourth information may be generated by the target model based on the target input according to the searched related knowledge and the first information. Based on this, if the first information is different, the fourth information generated by the object model based on the searched related knowledge and the first information based on the object input is different.

According to the data processing method provided by the embodiments of the present disclosure, after obtaining the target input, if the target input meets the first condition, the first information related to the input object is obtained, and the fourth information is output based on the first information. The fourth information includes the first output or the second output. The first output or the second output is generated by the target model based on the target input, and the first output is different from the second output. That is, the different outputs are obtained according to the different first information related to the input object, and the output mode is changed, so that the input object obtains the personalized output related to the first information. In this way, the interaction mode with the input object is increased, the intelligence of the data processing system based on the large model is improved, and the requirement of the input object on the interaction intelligence is met.

In some embodiments, outputting the fourth information based on the first information includes the following.

If the first information characterizes the input object as a first input object, the fourth information including the first output is output. As shown in FIG. 7B, after obtaining the target input of the first input object A, the first information is obtained, and the fourth information is output based on the first information. In this example, the target input is “Help me keep up with some of the mainstream ideas recently expressed by famous experts from the top 3 companies in the patent drafting field,” and the first output is “In patent drafting field, top-ranked companies generally include . . . ”

If the first information characterizes that the input object is a second input object, the fourth information including the first output is output. The first input object is different from the second input object. Another example is shown in FIG. 7C, after obtaining the target input by the second input object B, the first information is obtained, and the fourth information is output based on the first information according to the embodiments of the present disclosure. In this example, the object input is “Help me keep up with some of the mainstream ideas recently expressed by famous experts from the top 3 companies in the patent drafting field,” and the second output is “Understanding the main stream ideas in the patent field can help you better understand the importance and commercial value of intellectual property right . . .”

That is, when different input objects input the same target input, the first information associated with the different input objects is obtained, and the first information associated with the different input objects is generally different, and thus, the target outputs generated by the target model based on the target inputs are different.

In some embodiments, outputting the fourth information based on the first information includes the following.

If the first information characterizes the time that the input object is able to wait for meets the second condition, the fourth information including the first output is output. The quality of the first output is higher than the quality of the second output. As shown in FIG. 7D, after obtaining the target input by the first input object A, the first information is obtained, and the fourth information is output based on the first information. In this example, the target input is “Why global climate change is leading to an increase in extreme weather events?” and the first output is “Global climate change is a complicated and multidimensional issue, involving . . . ” In this example, the first input object A has enough time to wait for the model to generate an answer, so the content of the first output is richer and more profound.

The time that the input object can wait meeting the second condition devices that the input object can wait longer, and the target model has enough time to generate higher quality output. The time that the input object can wait not meeting the second condition devices that the input object can wait shorter, and the target model does not have enough time to generate higher quality output, thus only lower quality output can be obtained. As shown in FIG. 7E, after obtaining the target input by the first input object A, the first information is obtained, and the fourth information is output based on the first information. In this example, the target input is “Why global climate change is leading to an increase in extreme weather events?” and the second output is “Considering that you have a meeting in 5 minutes, the following is provided for your convenience . . . ” In this example, the first input object A only has a few minutes to wait for the model to generate an answer, so the content of the second output is relatively brief.

That is, if the first information associated with the first input object characterizes that the time the first input object can wait meets the second condition, and the first information associated with the second input object characterizes that the time the second input object can wait does not meet the second condition, then the quality of the first output is higher than the quality of the second output.

Or, if the first information associated with the first input object characterizes that the time the first input object can wait meets the second condition, the fourth information including the first output is output. If the first information associated with the first input object characterizes that the time the second input object can wait does not meet the second condition, the fourth information including the second output is output. The quality of the first output is higher than the quality of the second output.

In some embodiments, outputting the fourth information based on the first information includes the following.

If the first information characterizes the understanding of the domain to which the target input belongs by the input object meets the third condition, the fourth information including the first output is output. The quality of the first output is higher than the quality of the second output. Another interaction example is shown in FIG. 7F. After obtaining the target input by the input object, the fourth information is output based on the first information according to the embodiments of the present disclosure. In this example, the target input is “How to determine applicable laws and jurisdictions in an international business dispute involving multinational laws?” and the first output is “In an international business dispute involving multinational laws, determining laws and jurisdictions to use are a complex and crucial issue. The following are some specific methods and suggestions based on knowledge and practical experience in the legal field . . . ” In this example, the input objects are practitioners in the legal field, so the answers given are relatively rich in content (due to space limitations, some content is omitted) and of relatively high quality.

The understanding of the domain to which the target input belongs by the input object meets the third condition, which devices that the input object is an expert in the domain to which the target input belongs and a deeper output of the content needs to be given. If the understanding of the domain to which the target input belongs by the input object does not meet the third condition, which indicates that the input object has less knowledge of the domain to which the target input belongs and a shallow and understandable output of the content needs to be given. As shown in FIG. 7G, the fourth information is output based on the first information after obtaining the target input of the input object input according to the embodiments of the present disclosure. In this example, the target input is “How to determine applicable laws and jurisdictions in an international business dispute involving multinational laws?” and the second output is “In an international business dispute involving multinational laws, determining laws and jurisdictions to use are a complex and crucial issue. The following are some basic guidelines and methods . . . ” In this example, the input object is not a practitioner in the legal field, and has little knowledge about law, so the answer content given is simple (limited by space, some of which are omitted) and of relatively low quality.

That is, if the first information associated with the first input object characterizes the understanding the domain to which the target input belongs by the first input object meeting the third condition, and the first information associated with the second input object characterizes the understanding the domain to which the target input belongs by the second input object not meeting the third condition, then quality of the first output is higher than the quality of the second output.

In some embodiments, outputting the fourth information based on the first information includes the following.

If the first information characterizes the input object is a first input object and is in a first scene, the fourth information including the first output is output, as shown in FIG. 7D.

If the first information characterizes the input object is a first input object and is in a second scene, the fourth information including a second output is output. The first scene is different from the second scene, as shown in FIG. 7E.

That is, when the same input object inputs a target input in different scenes, if different first information associated with the input object is obtained, the target model generates different target outputs based on the target input.

The first scene and the second scene may be the different input environments in which the input object is located. For example, the first scene is the time in which the input object is in is a first target time period (e.g., 9:00-22:00), the location is a first target location (e.g., company). The second scene is the time in which the input object is in is a non-first target time period (e.g., 22:00 to 9:00 the next day), the location is a non-first target location (e.g., home).

When the input object is in different scenes, the time that the input object can wait may be different, and the quality of the first output and second output may be different.

In some embodiments, outputting the fourth information based on the first information, may further include the following.

Fifth information and/or sixth information is output.

The fifth information includes at least one piece of source data and an association display relation between the source data and output included by the fourth information. The source data may include, but is not limited to, at least one of the following data: article, software (also called an application), a knowledge base, etc.

That is, when outputting the fourth information, the associated source data referenced when the target model generates the target output (first output or second output) based on the target input is also output. The association between the fourth information and the source data may include but is not limited to the association of each segment in the fourth information with the source data.

Further, after obtaining the selection instruction for any one of the segments in the fourth information, the source data associated with any one of the segments is highlighted, so that the input object knows that the selected segment is generated based on the highlighted source data.

The sixth information includes source data with an identification characterizing the input object as having an association with the source data. As shown in FIG. 7H, reference are made to 5 documents to obtain the fourth information. The 2nd document in which, “2.COP26| climate report interpretation: extreme weather event is an important threat of global warming” is associated with an eye pattern, [symbol] characterizing the input object has viewed this document.

That is, if there is source data associated with the input object in at least one piece of source data, for example, source data browsed by the input object, or source data created by the input object, then when outputting the source data associated with the input object, an identifier is added to the source data so that the input object knows that it is associated with the identified source data.

If the association relationship between the input object and the source data is different, the identification of the source data may also be different. For example, if the source data has a first identification, that characterizes that the input object has viewed the source data. If the source data has a second identification, that characterizes that the source data is created by the input object.

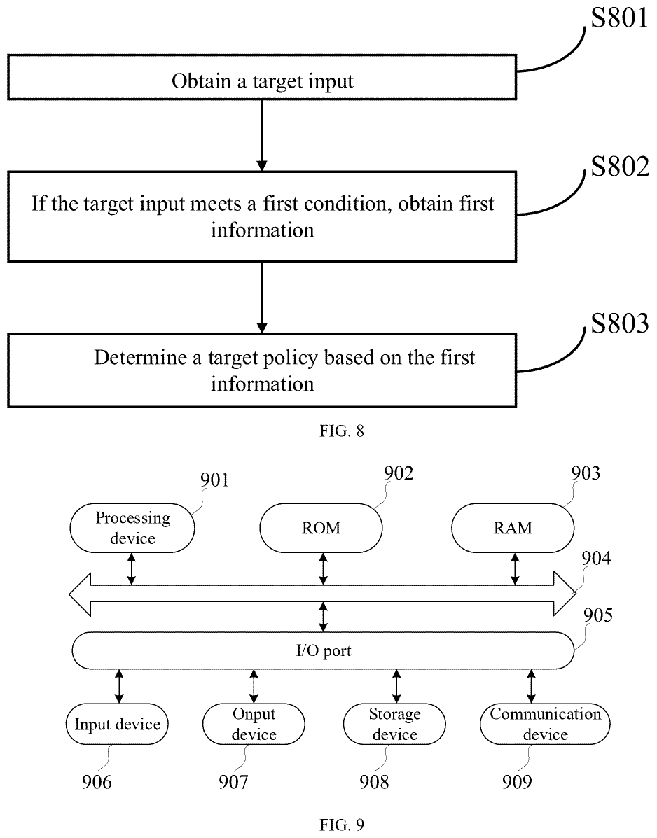

In some embodiments, a flowchart of still another implementation of the data processing method provided by the present disclosure is shown in FIG. 8, which includes the following.

At S801, a target input is obtained.

The target input is interactive content input by an input object (e.g., a user) and may include, but is not limited to, content in at least one of following format: text, file, image, etc.

At S802, if the target input meets the first condition, the first information is obtained.

The first condition is used to determine whether an output policy needs to be selected.

In some embodiments, the target input meeting the first condition may include the target input is a complex problem. Reference can be made to above disclosure for determining whether the target input is a complex problem.

In some embodiments, the first information may include information related to at least one of the following information: an input object, an input environment, and an electronic device.

In some embodiments, the information related to the input object and/or the input environment may include, but is not limited to, at least one of following information: identity of the input object, personality, time of day, location, browsing history, job title, years of working experience, etc.

The information associated with the electronic device may include, but is not limited to, at least one of the following: core number, main frequency and cache size of the processor, memory capacity and frequency, hard disk type and storage capacity, video memory size, number of stream processors, bus width, software performance, etc.

At S803, a target policy is determined based on the first information.

If the first information is different, then the determined target policy is different.

The target policy characterizes a policy for generating a target output, including any of the following.

A model matching the first information is selected as a target model from a plurality of models according to the first information, and target output is generated based on the target model.

A number of times of calling the target model is determined based on the first information.

The steps of generating the target output by the target model based on the target input are determined according to the first information.

The depth of searching information (i.e., the information search depth) in a preset information source (such as a website, or a free knowledge base, etc.) or a selected knowledge base based on target input is determined according to the first information.

The breadth of searching information (i.e., the information searching breadth) in a preset information source or a selected knowledge base based on target input according to the first information.

Any two of the plurality of models are different models, and the differences of models may include at least one of following: differences in the publishers of the models, differences in the kinds of models (e.g., models that are good at abstracts, models that are good at reasoning, models that are good at classification, etc.), differences in the versions of the models, etc.

According to the preset corresponding relation between the first information and the models, the model corresponding to the obtained first information in the models can be used as the model matching the first information, i.e., the target model.

Or each of the plurality of models may be used as a category to categorize the first information, to determine to which model of the plurality of models the first information belongs, and the determined category to which the first information belongs may be determined as a model matching the first information, i.e., the target model.

Or the waiting time of the input object and/or the understanding by the input object of the domain of the target input can be determined according to the first information. According to the predetermined correspondence between the waiting time and/or the degree of understanding of the target input domain and the model, the model corresponding to the waiting time of the input object and/or the degree of understanding of the target input domain by the input object is determined as the model matching the first information, i.e., the target model.

Or the requirement of the input object can be firstly determined based on the target input. After determining the waiting time of the input object and/or the understanding degree of the input object of the domain of the target input according to the first information, the model corresponding to the waiting time of the input object and/or the understanding degree of the input object of the domain of the target input can be determined as the model matching the first information, i.e., the target model, in the model capable of realizing the requirement of the input object according to the preset corresponding relation between the waiting time and/or the understanding degree of the input object of the domain of the target input and the model.

There may be only one or a plurality of object models. In the case where there is a plurality of object models, the plurality of object models may be models of different publishers of the same kind, or may be models of different versions of the same kind. The target outputs may be generated by each model based on the target input, and then the final target output may be selected from among the target outputs generated by different target models, or the target outputs generated by different target models may be combined to obtain the final target output.

In some embodiments, after determining the target model, the depth of an algorithm for generating the target output by the target model based on the target input, that is, the number of calls to the target model, may also be determined according to the first information. For example, if the first information characterizes that the input object can wait longer or the input object has a better understanding of the domain to which the target input belongs, the number of calls to the target model can be larger to give a more accurate and in-depth output, otherwise, the number of calls to the target model can be smaller to give a more accurate and understandable output.

In some embodiments, after determining the target model, the steps of generating the target output based on the target input by the target model according to the first information can be determined. For example, a number of steps of generating the target output by the target moder can be determined based on the target input. The number of steps of the generating the target output by the target model based on the target input may be determined according to the behavior data of the input object. For example, the input object wants the large model to help recommend a hot pot. The general process is that the large model determines the user's requirement according to the target input, then collects the related data, and then screens out the hotpot shop meeting the requirement of the input object according to the collected related data to recommend to the input object. Consistent with the present disclosure, if the input object is interested in a certain hot pot according to the behavior of the input object before asking the large model, for example, the input object browses a certain software and views a certain hot pot multiple times in the software or chat history characterizes that the input object is interested in a certain hot pot, the large model can directly recommend the hot pot which is browsed multiple times or showed interest in the chat history by the input object to the input object without collecting related data. If the input object does not browse any software or the chat history does not show the interest of which hot pot before asking the large model, the user requirement can be determined according to the target input, then the related data is collected, and then the hot pot meeting the requirement of the input object is selected according to the collected related data and recommended to the input object.

In some embodiments, after determining the target model, determining, according to the first information, an information search depth in a preset information source or a knowledge base selected by the input object based on the target input. For example, if the first information characterizes that the input object has a higher degree of knowledge about the domain to which the target input belongs, the information search depth in the in a preset information source or a knowledge base selected by the input object based on the target input may be increased, otherwise, the information search depth may be reduced.

In some embodiments, after determining the target model, determining, according to the first information, the information search breadth in a preset information source or a knowledge base selected by input object based on the target input. For example, if the first information characterizes the understanding of the input object involves multiple domains, the information search breadth in the knowledge base selected by the preset information source or a knowledge base selected by the target input may be increased, otherwise, the information search breadth may be reduced.

According to the data processing method provided by the present disclosure, after the target input is obtained, if the target input meets the first condition, the first information is obtained, the target policy is determined based on the first information, and the target policy is a policy for characterizing the generation of the target output. Consistent with the present disclosure, different policies for generating the target output are determined according to the different first information, so that the way of outputting the target output is changed. In this way, the input object obtains the personalized output associated with the first information, the interaction mode with the input object is increased, and the requirement of input object for intelligent interaction is met.

The embodiments of the present disclosure also provide an electronic device. The electronic device shown in FIG. 9 is only an example, and should not impose any limitation on the functions and scope of use of the embodiments of the present disclosure.

As shown in FIG. 9, the electronic device includes processing device (e.g., a central processor, a graphics processor, etc.) 901, which may execute various appropriate actions and processes according to programs stored in Read Only Memory (ROM) 902 or programs loaded from storage device 908 into Random Access Memory (RAM) 903. When the electronic device is powered on, various programs and data needed for the operation of the electronic device are also stored in the RAM 903. The processing device 901, the ROM 902, and the RAM 903 are connected to each other through bus 904. Input/output (I/O) port 905 is also connected to the bus 904.

In general, the following devices can be connected to I/O port 905: input device 906 including touch screen, touch pad, keyboard, mouse, camera, microphone, accelerometer, gyroscope, etc.; output device 907 including Liquid Crystal Display (LCD), speaker, vibrator, etc.; storage device 908 including memory cards, hard disks, etc.; and communication devices 909. Communication device 909 may allow the electronic device to communicate with other devices wirelessly or by wire to exchange data. While FIG. 9 shows an electronic device having various devices, that not all of the illustrated devices are needed to be implemented or provided. More or fewer devices may be implemented or provided instead.

Processing device 901 included in the electronic device is used for outputting the second information, and the second information is used for prompting a first time of obtaining a target output. The processing device 901 is further used for providing an environment for running the target model such that the target model generates the target output based on the target input. In some embodiments, when outputting the second information, the processing device 901 is used for obtaining a target input, obtaining the first information if the target input meets the first condition, and outputting the second information based on the first information.

And/or, processing device 901 included in the electronic device is used for obtaining a target input, obtaining first information if the target input meets a first condition, in which the first information is related to an input object, outputting the fourth information based on the first information, in which the fourth information includes a first output or a second output, and the first output or the second output is generated by a target model based on the target input, and the first output is different from the second output.

And/or, processing device 901 included in the electronic device is used for obtaining a target input, obtaining first information if the target input meets a first condition, determining a target policy based on the first information, and the target policy characterizing a policy for generating a target output, including any one of the following.

A model matching the first information is selected from a plurality of models according to the first information as a target model, and target output is generated based on the target model.

A number of calling the target model is determined according to the first information.

The steps of generating the target output by the target model based on the target input and target information is determined according to the first information.

The information search depth in a preset information source or the selected knowledge base is determined based on the target input according to the first information.

The information search breadth in the preset information source or the selected knowledge base is determined based on the target input according to the first information.

Embodiments of the present disclosure also provide a computer program product including computer-readable instructions. When the computer-readable instructions are executed on an electronic device, the electronic device can implement any of the data processing methods provided in the embodiments of the present disclosure.

The embodiments of the present disclosure also provide a computer readable storage medium, which carries one or more computer programs, and when the one or more computer programs are executed by the electronic device, the electronic device can implement any data processing method provided by the embodiments of the present disclosure.

The above-described devices are merely illustrative, and the units described as separate units may or may not be physically separate, and units shown as units may or may not be physical units, may located in one place, or may be distributed over a plurality of network units. Some or all of the modules may be selected according to actual needs to achieve the purpose of the solution of this example. In addition, in the drawings of the embodiments of the device provided by the present disclosure, the connection relation between the modules represents that the modules have communication connection, and can be specifically implemented as one or more communication buses or signal lines.

In the embodiments of the present disclosure, the claims, the various embodiments, and the features may be combined with each other, so as to solve the foregoing technical problems.

From the above description of the embodiments, it will be apparent to those skilled in the art that the present disclosure may be implemented by devices of software plus necessary general purpose hardware, or of course by devices of special purpose hardware including application specific integrated circuits, special purpose CPUs, special purpose memories, special purpose components, etc. Generally, functions executed by computer programs can be easily implemented by corresponding hardware, and specific hardware structures for implementing the same functions can be varied, such as analog circuits, digital circuits, or dedicated circuits. But for the present disclosure a software program implementation is a preferred embodiment in many more cases. Based on such understanding, the technical solution of the present disclosure may be embodied essentially or in a part contributing to the technology in the form of a software product stored in a readable storage medium, such as a floppy disk, a usb disk, a removable hard disk, a ROM, a RAM, a magnetic disk or an optical disk of a computer, etc., including several instructions for causing a computer device (which may be a personal computer, a training device, or a network device, etc.) to execute the method according to the embodiments of the present disclosure.

In the above embodiments, it may be implemented in whole or in part by software, hardware, firmware, or any combination thereof. When implemented in software, may be implemented in whole or in part in the form of a computer program product. Skilled artisans may implement the described functionality in varying ways for each particular implementation, but such implementation decisions should not be interpreted as causing a departure from the scope of the present disclosure.

The computer program product includes one or more computer instructions. When loaded and executed on a computer, produces a flow or function in accordance with embodiments of the present disclosure, in whole or in part. The computer may be a general purpose computer, a special purpose computer, a computer network, or other programmable apparatus. The computer instructions may be stored in a computer-readable storage medium or transmitted from one computer-readable storage medium to another computer-readable storage medium, for example, the computer instructions may be transmitted from one website, computer, training device, or data center to another website, computer, training device, or data center via a wired (e.g., coaxial cable, optical fiber, digital Subscriber Line (DSL)) or wireless (e.g., infrared, wireless, microwave, etc.). The computer readable storage medium may be any available medium that can be stored by a computer or a data storage device such as a training device, a data center, or the like that contains an integration of one or more available media. The usable medium may be a magnetic medium (e.g., floppy disk, hard disk, tape), an optical medium (e.g., DVD), or a semiconductor medium (e.g., solid state disk (Solid STATE DISK, SSD)), etc.

In the present specification, each embodiment is described in a progressive manner, and each embodiment is mainly described in a different point from other embodiments, and identical and similar parts between the embodiments are all enough to refer to each other.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

What is claimed is:

1. A method of data processing comprising:
obtaining a target input;
obtaining, in response to the target input meeting a condition, first information; and
outputting second information based on the first information, the second information prompting a time for obtaining a target output generated by a target model based on the target input, and the time being related to the first information.

2. The method according to claim 1, wherein:
the first information includes at least one of:
first sub-information characterizing a processing performance of an electronic device running the target model,
second sub-information characterizing an occupancy of available processing resources of the electronic device by a non-target model, or
third sub-information characterizing understanding of a domain to which the target input belongs by an input object; and
outputting the second information based on the first information includes determining the time based on one or more of the at least one of the first sub-information, the second sub-information, or the third sub-information, and outputting the second information.

3. The method according to claim 1, wherein:
the time is a first time;
the first information includes sub-information related to at least one of an input object or an input environment; and
outputting the second information based on the first information includes:
determining a second time based on the sub-information, the second time characterizing a time that the input object is able to wait; and
outputting the second information based on the first time and the second time, the second information further prompting the input object to trigger the target model to run or to execute another task.

4. The method according to claim 1, wherein:
the condition is a first condition; and
the first information includes sub-information characterizing understanding of a domain to which the target input belongs by an input object;
the method further comprising:
determining an understanding degree of the input object of the domain based on the sub-information; and
outputting third information based on the time in response to the understanding degree meeting a second condition, the third information prompting to select a knowledge base.

5. An electronic device comprising:
at least one memory storing one or more instructions; and
at least one processor configured to execute the one or more instructions to perform the method according to claim 1.

6. The electronic device according to claim 5, wherein:
the first information includes at least one of:
first sub-information characterizing a processing performance of an electronic device running the target model,
second sub-information characterizing an occupancy of available processing resources of the electronic device by a non-target model, or
third sub-information characterizing understanding of a domain to which the target input belongs by an input object; and
the at least one processor is further configured to execute the one or more instructions to, when outputting the second information based on the first information, determine the time based on one or more of the at least one of the first sub-information, the second sub-information, or the third sub-information, and outputting the second information.

7. The electronic device according to claim 5, wherein:
the time is a first time;
the first information includes sub-information related to at least one of an input object or an input environment; and
the at least one processor is further configured to execute the one or more instructions to, when outputting the second information based on the first information:
determine a second time based on the sub-information, the second time characterizing a time that the input object is able to wait; and
output the second information based on the first time and the second time, the second information further prompting the input object to trigger the target model to run or to execute another task.

8. The electronic device according to claim 5, wherein:
the condition is a first condition; and
the first information includes sub-information characterizing understanding of a domain to which the target input belongs by an input object;
the at least one processor is further configured to execute the one or more instructions to:
determine an understanding degree of the input object of the domain based on the sub-information; and
output third information based on the time in response to the understanding degree meeting a second condition, the third information prompting to select a knowledge base.

9. A non-transitory computer-readable storage medium storing one or more instructions that, when executed by a processor, cause an electronic device including the processor to perform the method of claim 1.

10. A method of data processing comprising:
obtaining a target input;
obtaining first information in response to the target input meeting a condition, the first information being related to an input object; and
outputting second information based on the first information, the second information including a first output or a second output generated by a target model based on the target input, and the first output being different from the second output.

11. The method according to claim 10, wherein outputting the second information based on the first information includes:
outputting the first output in response to the first information characterizing that the input object is a first input object; and
outputting the second output in response to the first information characterizing that the input object is a second input object different from the first input object.

12. The method according to claim 10, wherein outputting the second information based on the first information includes:
outputting the first output in response to the first information characterizing that the input object is in a first scene; and
outputting the second output in response to the first information characterizing that the input object is in a second scene different from the first scene.

13. The method according to claim 10, wherein:
the condition is a first condition; and
outputting the second information based on the first information includes at least one of:
outputting the first output in response to the first information characterizing that a time that the input object is able to wait meets a second condition; or
outputting the first output in response to the first information characterizing that an understanding degree of a domain to which the target input belongs by the input object meets a third condition, and a quality of the first output is higher than a quality of the second output.

14. The method according to claim 10, further comprising, when outputting the second information based on the first information:
outputting at least one of third information or fourth information;
wherein:
the third information includes source data and an association display relation between the source data and an output included in the second information; and
the fourth information includes source data with an identification characterizing that the input object has an association with the source data.

15. An electronic device comprising:
at least one memory storing one or more instructions; and
at least one processor configured to execute the one or more instructions to perform the method according to claim 10.

16. A non-transitory computer-readable storage medium storing one or more instructions that, when executed by a processor, cause an electronic device including the processor to perform the method of claim 10.

17. A method of data processing comprising:
obtaining a target input;
obtaining information in response to the target input meeting a condition; and
determining, based on the information, a target policy for generating a target output;
wherein the target policy includes at least one of:
selecting a target model matching the information from a plurality of models, and generating a target output based on the target model;
determining a number of times of calling the target model according to the information;
determining, according to the information, one or more steps by which the target model generates the target output based on the target input and target information;
determining, according to the information, a depth of searching information in a preset information source or a selected knowledge base based on the target input; or
determining, according to the information, a breadth of searching information in the preset information source or the selected knowledge base based on the target input.

18. An electronic device comprising:
at least one memory storing one or more instructions; and
at least one processor configured to execute the one or more instructions to perform the method according to claim 17.

19. A non-transitory computer-readable storage medium storing one or more instructions that, when executed by a processor, cause an electronic device including the processor to perform the method of claim 17.
